(19) United States
(12) Patent Application Publication
(10) Pub. No.: US 2015/0256937 A1
(43) Pub. Date: Sep. 10, 2015

(54) COMPOSITE DIAPHRAGM

(71) Applicant: MERRY ELECTRONICS (SUZHOU) CO., LTD., SUZHOU CITY (CN)

(72) Inventors: Ching-Lan LIN, Taichung City (TW); Chen-Mao YANG, Taichung City (TW); Po-Yu CHEN, Taichung City (TW); Yi-Lin HSIEH, Taichung City (TW); Feng-Min LAI, Taichung City (TW)

(21) Appl. No.: 14/307,965

(22) Filed: Jun. 18, 2014

(30) Foreign Application Priority Data
Mar. 6, 2014 (TW) 103107742

(51) Int. Cl. H04R 7/02

(52) U.S. Cl. CPC H04R 7/02

(57) ABSTRACT

A composite diaphragm is provided to include a base layer and a micro-nanometer ceramic layer disposed on the surface of the base layer. The micro-nanometer ceramic is a structural material that has great stiffness and toughness, such that the composite diaphragm made of micro-nanometer ceramic manifests characteristics of high stiffness, high toughness, and great ductility. Thus, the composite diaphragm allows large deformation at room temperature to achieve high capability of producing high-definition tone.

### BACKGROUND OF THE INVENTION

1. Technical Field

The present invention relates to speaker diaphragms, and more particularly, to a composite diaphragm for use in a speaker.

2. Description of Related Art

With the popularity and advancement of digital media, not only is high fidelity (Hi-Fi) the trend of development of digital music, but professional speaker R&D is also all the rage. Diaphragm is one of the crucial parts of a speaker in order for the speaker to manifest excellent audio output characteristics.

Given the same size and shape, the diaphragm must be stiff and tough enough to survive vigorous reciprocal movement and prevent inelastic deformation or even rupture. In order to solve the aforesaid problem, a ceramic diaphragm is provided by coating the surface of a diaphragm with an engineering ceramic for enhancing mechanical properties. However, the ceramic diaphragm has a disadvantage of high brittleness to reduce ductility, and therefore it will affect energy distribution and provide low-definition tone.

Accordingly, it is imperative to provide a diaphragm with high stiffness, high toughness and improved ductility.

### SUMMARY OF THE INVENTION

It is an objective of the present invention to provide a composite diaphragm with high stiffness, high toughness, and great low-temperature ductility.

In order to achieve the above objective, the present invention provides a composite diaphragm comprising a base layer and at least one micro-nanometer ceramic layer disposed on the surface of the base layer. Since the micro-nanometer ceramic layer is a material having enhanced stiffness and toughness, the composite diaphragm of the present invention has advantages of high stiffness, high toughness, and great low-temperature ductility, and may allow large deformation at room temperature, thereby achieving high capability of producing high-definition tone.

Preferably, the base layer has a central portion and a peripheral portion disposed around an outer periphery of the central portion. In order to meet different requirements, the micro-nanometer ceramic layer can be disposed on the upper surface of the central portion or the upper surface of the peripheral portion. Furthermore, the micro-nanometer ceramic layer can be configured in such a way that the micro-nanometer ceramic layer covers over the upper surface of the central portion and the upper surface of the peripheral portion simultaneously. Alternatively, the composite diaphragm may comprise two micro-nanometer ceramic layers, namely a first micro-nanometer ceramic layer and a second micro-nanometer ceramic layer disposed on the upper and lower surfaces of the central portion, respectively.

### BRIEF DESCRIPTION OF THE DRAWINGS

FIG. 1 is a schematic cross-sectional view of a composite diaphragm according to the first embodiment of the present invention;

FIG. 2 is a schematic cross-sectional view of the composite diaphragm according to the second embodiment of the present invention;

FIG. 3 is a schematic cross-sectional view of the composite diaphragm according to the third embodiment of the present invention; and

FIG. 4 is a schematic cross-sectional view of the composite diaphragm according to the fourth embodiment of the present invention.

### DETAILED DESCRIPTION OF THE INVENTION

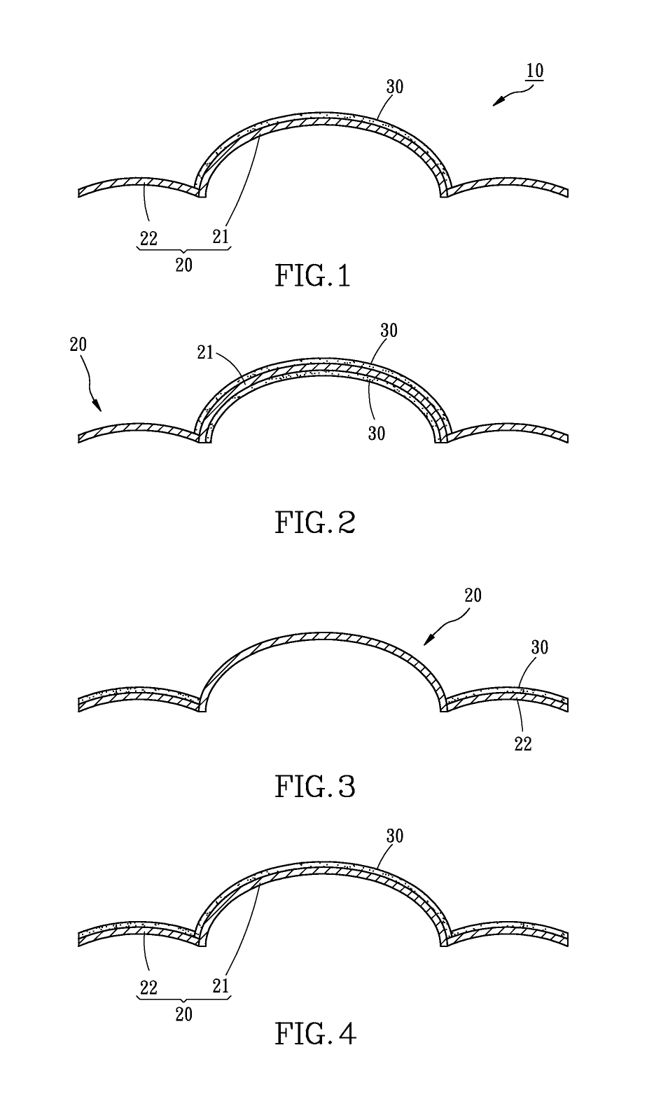

Referring to FIG. 1, a composite diaphragm 10 in accordance with the first embodiment of the present invention comprises a base layer 20 and a micro-nanometer ceramic layer 30.

The base layer 20 can be, but not limited to, made of metal, polymer, fabric, silk, linen, paper, or composite material. In this embodiment, the base layer 20 has a central portion 21 and a peripheral portion 22 disposed around the outer periphery of the central portion 21. The central portion 21 and the peripheral portion 22 each have a curved cross-section.

The micro-nanometer ceramic layer 30 is made of ceramic materials which have structured components with at least one dimension less than 500 micrometers. After it has been formed, the micro-nanometer ceramic layer 30 is fixed to the upper surface of the central portion 21 of the base layer 20 by a process, such as coating, transfer, adhesive, or fusion. Alternatively, the micro-nanometer ceramic layer 30 is directly coated on the upper surface of the central portion 21 of the base layer 20 by physical vapor deposition (PVD) or chemical vapor deposition (CVD).

To deserve to be mentioned, the number and position of the micro-nanometer ceramic layer 30 can be provided according to actual needs. As shown in FIG. 2, the upper and lower surfaces of the central portion 21 of the base layer 20 can be covered by the micro-nanometer ceramic layers 30. Referring to FIGS. 3 and 4, the micro-nanometer ceramic layer 30 can be disposed on the upper surface of the peripheral portion 22 of the base layer 20 or disposed on the upper surface of the central portion 21 of the base layer 20 and the upper surface of the peripheral portion 22 of the base layer 20, respectively.

As micro-nanometer ceramic is a material that has mechanical properties of the conventional engineering ceramic and improves brittle problem of the conventional engineering ceramic, the stiffness, toughness, and ductility of the composite diaphragm 10 of the present invention can be evidently enhanced by using the micro-nanometer ceramic layer 30. Thus, the composite diaphragm 10 of the present invention has advantages of high stiffness, high toughness, and great low-temperature ductility to allow great deformation at room temperature, thereby achieving high capability of producing high-definition tone.

What is claimed is:

1. A composite diaphragm, comprising:
a base layer; and
at least one micro-nanometer ceramic layer disposed on a surface of the base layer.

2. The composite diaphragm of claim 1, wherein the base layer has a central portion and a peripheral portion disposed around an outer periphery of the central portion, and the at least one micro-nanometer ceramic layer is disposed on an upper surface of the central portion.

3. The composite diaphragm of claim 2, wherein the central portion and the peripheral portion each have a curved cross-section.

4. The composite diaphragm of claim 1, wherein the base layer has a central portion and a peripheral portion disposed around an outer periphery of the central portion, and the at least one micro-nanometer ceramic layer is disposed on an upper surface of the peripheral portion.

5. The composite diaphragm of claim 4, wherein the central portion and the peripheral portion each have a curved cross-section.

6. The composite diaphragm of claim 1, wherein the base layer has a central portion and a peripheral portion disposed around an outer periphery of the central portion, and the at least one micro-nanometer ceramic layer is disposed on an upper surface of the central portion and an upper surface of the peripheral portion.

7. The composite diaphragm of claim 6, wherein the central portion and the peripheral portion each have a curved cross-section.

8. The composite diaphragm of claim 1, wherein the base layer has a central portion and a peripheral portion disposed around an outer periphery of the central portion; the at least one micro-nanometer ceramic layer comprises first and second micro-nanometer ceramic layers that are disposed on an upper surface and a lower surface of the central portion, respectively.

9. The composite diaphragm of claim 8, wherein the central portion and the peripheral portion each have a curved cross-section.
